(19) United States
(12) Patent Application Publication
(10) Pub. No.: US 2023/0125243 A1
(43) Pub. Date: Apr. 27, 2023

(54) ELECTRIC SOFA FOR RECREATIONAL VEHICLE

(71) Applicant: BlackSeries Intelligent Equipment (Weihai) Co., Ltd, Weihai (CN)

(72) Inventors: Xinna LIU, Weihai (CN); Zhuhua SUN, Weihai (CN); Peng WANG, Weihai (CN); Guang XU, Weihai (CN)

(21) Appl. No.: 17/744,622

(22) Filed: May 13, 2022

(30) Foreign Application Priority Data
Oct. 27, 2021 (CN) 2021112521743

(51) Int. Cl. B60P 3/36; A47C 17/04; B60P 3/34

(52) U.S. Cl. CPC B60P 3/36; A47C 17/04; B60P 3/34

(57) ABSTRACT

An electric sofa for recreational vehicle is provided with a sofa combined cabinet. The sofa combined cabinet includes a first sofa cabinet, a second sofa cabinet and a third sofa cabinet. The sofa combined cabinet is of U-shaped distribution. The third sofa cabinet is provided with a telescopic plate, the telescopic plate is located at one side of the third sofa cabinet close to the second sofa cabinet, the telescopic plate is provided with a telescopic plate driving device fixed on the floor of the recreational vehicle. The third sofa cabinet is provided with a sofa cabinet driving device. The bottom of the third sofa cabinet is provided with a slide rail device, the telescopic plate is unfolded or contracted under the driving of the telescopic plate driving device, the third sofa cabinet is driven by the sofa cabinet driving device to move along the slide rail device.

### CROSS REFERENCE TO RELATED APPLICATION

This patent application claims the benefit and priority of Chinese Patent Application No. 202111252174.3 filed on Oct. 27, 2021, the disclosure of which is incorporated by reference herein in its entirety as part of the present application.

### TECHNICAL FIELD

The invention relates to the technical field of recreational vehicle facility, and more specifically, to an electric sofa for recreational vehicle.

### BACKGROUND ART

With the improvement of the living standard and the rapid development of the vehicle, the recreational vehicle travel as a new travel mode becomes popular with more and more people. The recreational vehicle not only has the function of alternation for walking, the carriage thereof also has strong multi-functions. The recreational vehicle carriage is often provided with a rest bed, the sofa tea table combination, hand-washing platform and bathroom. When the recreational vehicle is running, people can sit on the sofa tea table for chatting, when the recreational vehicle is parked at the camping ground, the toilet and shower between the bathroom can be used. It also can sleep on the rest bed, these are the advantages of the recreational vehicle as a travel tool, since the recreational vehicle space is relatively small, wherein the sofa and bed occupy a larger space, the space in the vehicle is reduced, the existing recreational vehicle is designed to fix the sofa in the carriage. The sofa is not movably adjusted, however, a wider passage is reserved beside the sofa, which results in less seat number of the sofa and crowding. The user gets on and off the car through the vehicle door position, so the sofa cannot be set at the car door position. A foldable electric sofa for recreational vehicle is desired, wherein leisure electric sofa is unfolded to function as bed. While when the user gets on and off, the electric sofa is folded to avoid the sofa from blocking the door, therefore, one can be used as a bed, and the foldable electric sofa of the sofa is more and more popular with the room vehicle manufacturer.

### SUMMARY

In order to solve the above problem, an electric sofa for recreational vehicle is provided, aiming at solving the problem that the sofa occupies larger space in the market, which reduces the use space in the vehicle, the sofa is not movably adjusted, the seat number of the sofa is less, the sofa is easy to block the problem of the vehicle door.

The embodiment of the invention claims an electric sofa for recreational vehicle, provided with a sofa combined cabinet, the sofa combined cabinet is composed of three sofa cabinets. The first respectively cabinet and the second sofa cabinet are composed of a first sofa cabinet and a second sofa cabinet, the third sofa cabinet, the sofa combined cabinet is U-shaped distribution. The third sofa cabinet is provided with a telescopic plate and the telescopic plate is located at one side of the third sofa cabinet close to the second sofa cabinet. The telescopic plate is provided with a telescopic plate driving device fixed on the floor of the recreational vehicle. The third sofa cabinet is provided with a sofa cabinet driving device. The bottom of the third sofa cabinet is provided with a slide rail device.

In one embodiment, the first sofa cabinet and the third sofa cabinet is respectively provided with a supporting plate, the supporting plate is respectively connected with the supporting plate driving device.

In one embodiment, the supporting plate driving device is fixed in the sofa cabinet, the supporting plate driving device is connected with the supporting plate through the hinge. Each supporting plate is connected with the two supporting plate driving device. The supporting plate driving device is respectively at two ends of the supporting plate.

In one embodiment, the telescopic plate includes two plates. The two plates are hinged by a first telescopic plate hinge. The first telescopic plate hinge is located at the outer side of the telescopic plate. The telescopic plate is hinged with the third sofa cabinet through the second telescopic plate hinge. The second telescopic plate hinge is located at the inner side of the third sofa cabinet.

In one embodiment, the piston rod of the telescopic plate driving device is hinged with the telescopic plate push rod. One end of the telescopic plate push rod is fixed on the recreational vehicle floor through the hinge mode. The other end is provided with a roller. The length of the telescopic plate push rod is greater than the height of the telescopic plate and the recreational vehicle floor.

In one embodiment, the sofa cabinet driving device is fixed on the recreational vehicle floor. The piston rod of the sofa cabinet driving device is connected with the sofa cabinet push rod through hinge mode. One end of the sofa cabinet push rod is fixed on the recreational vehicle floor by hinge mode. The other end is connected with the hydraulic rod through the hinge mode. The other end of the hydraulic rod is movably connected with the connecting sheet fixed on the inner side of the third sofa cabinet.

In one embodiment, the sofa combined cabinet is further provided with a sofa backrest, the sofa cabinet is respectively provided with a cabinet door, the cabinet door can be opened.

In one embodiment, the first sofa cabinet and the third sofa cabinet is respectively provided with a supporting plate slot, the depth of the supporting plate slot is the same as the thickness of the supporting plate.

In one embodiment, the sofa combined cabinet is provided with a rib plate.

In one embodiment, it is further provided with a lifting table.

The beneficial effects of the disclosure are:

The invention claims an electric sofa for recreational vehicle, provided with a sofa combined cabinet, the sofa combined cabinet includes three sofa cabinets. The first respectively cabinet and the second sofa cabinet are composed of a first sofa cabinet and a second sofa cabinet, the third sofa cabinet, the sofa combined cabinet is U-shaped distribution, the third sofa cabinet is provided with a telescopic plate, the telescopic plate is located at one side of the third sofa cabinet close to the second sofa cabinet, the telescopic plate is provided with a telescopic plate driving device fixed on the floor of the recreational vehicle, the third sofa cabinet is provided with a sofa cabinet driving device, the bottom of the third sofa cabinet is provided with a slide rail device, the telescopic plate is driven by the telescopic plate driving device to unfold or shrink, the third sofa cabinet moves along the slide rail device under the driving of the sofa cabinet driving device. When the telescopic plate shrinks, the third sofa cabinet is retracted, the sofa length is reduced, and the space utilization in the vehicle is increased. It can reserve a wider passage and avoids the long length of the sofa to block the door of the recreational vehicle. The first sofa cabinet and the second sofa cabinet are further provided with a supporting plate. When it is necessary to rest in the vehicle, the telescopic plate is unfolded, the third sofa cabinet extends out, the supporting plate is opened, the lifting table is matched, the unfolded area of the sofa combined cabinet is increased. After unfolding, it can be used as a bed. Therefore, the electric sofa can be used as a bed, and it can be popular by the motor home when the sofa is used, it solves the problem that the sofa occupies larger space in the market and reduces the use space in the vehicle; the sofa is not adjustable, the seat number of the sofa is small, the sofa is easy to block the problem of the door.

### BRIEF DESCRIPTION OF THE DRAWINGS

FIG. 1 is a structure schematic diagram of the disclosure;

FIG. 2 is a first sofa cabinet structure schematic diagram;

FIG. 3 is a telescopic plate and telescopic plate driving device position schematic diagram;

FIG. 4 is a telescopic plate driving device structure schematic diagram;

FIG. 5 is a third sofa inner structure schematic diagram;

FIG. 6 is a sofa cabinet driving device structure schematic diagram;

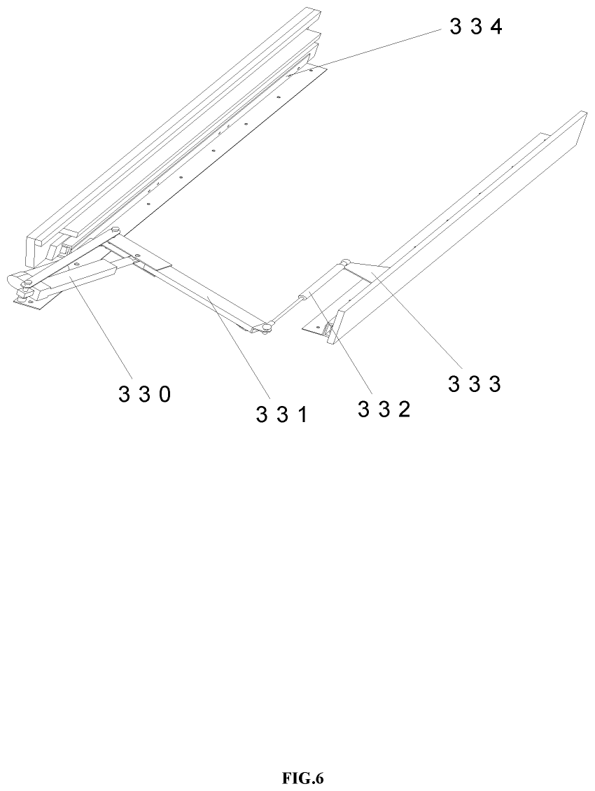

FIG. 7 is a second supporting plate driving device position diagram;

In the drawings:
10, sofa combined cabinet;
1: the first sofa cabinet;
110: first supporting plate; 120. first supporting plate driving device; 130: first supporting plate slot;
2, the second sofa cabinet;
3, the third sofa cabinet;
310) telescopic plate; 311. first telescopic plate hinge;
320. telescopic plate driving device; 321, the telescopic plate push rod; 322: idler wheel;
330, the sofa cabinet driving device; 331, the push rod of the sofa cabinet; 332: hydraulic rod; 333) connecting sheet; 334, a slide rail device;
340. second supporting plate; 341. second supporting plate driving device; 342. second supporting plate slot;
4, sofa backrest;
5, the cabinet door;
6. A rib plate.

### DETAILED DESCRIPTION OF THE EMBODIMENTS

In order to solve the technical problem to be solved by the present application, the technical solution and beneficial effect are more clearly understood, the following combine the accompanying drawings and examples, for further detailed explanation of this application. It should be understood that the specific embodiment described herein is only for explaining the application, and not for defining the application.

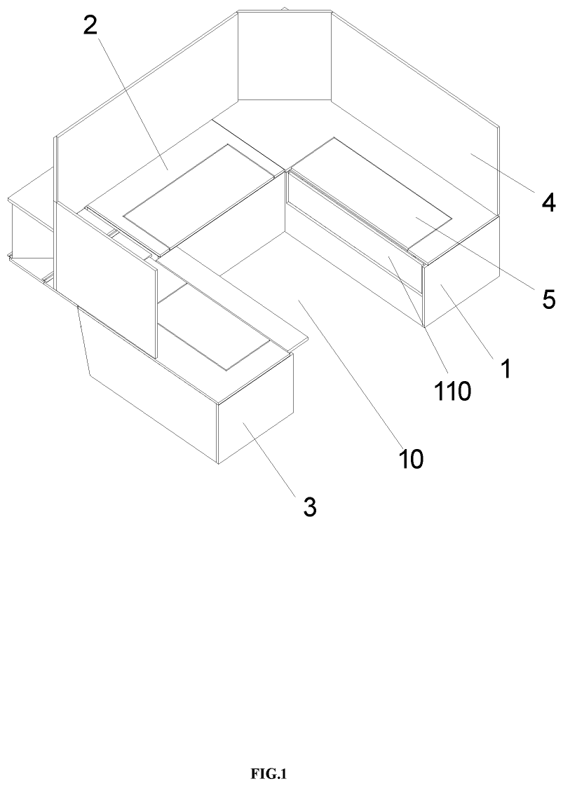

As shown in FIG. 1, a recreational vehicle electric sofa is provided with a sofa combined cabinet 10. The sofa combined cabinet 10 includes three sofa cabinets, which is the first sofa cabinet 1, the second sofa cabinet 2 and the third sofa cabinet 3. The sofa combined cabinet 10 is of U-shaped distribution, the first sofa cabinet 1 and the second sofa cabinet 2 is fixed on the recreational vehicle floor and not movable. The third sofa cabinet 3 is movably connected with the recreational vehicle floor, it can move back and forth on the floor.

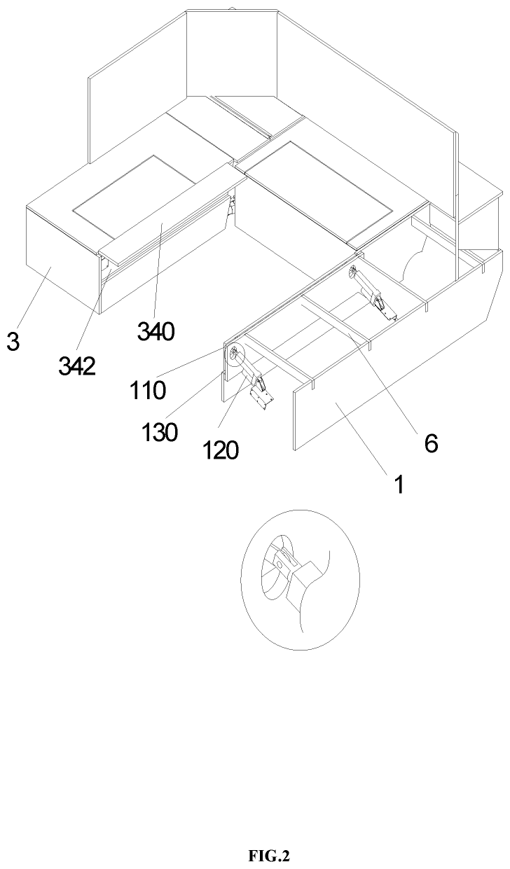

As shown in FIG. 1, the first sofa cabinet 1 is movably provided with a first supporting plate 110. The first support 110 is located at one side of the sofa combined cabinet 10 center. As shown in FIG. 1, first supporting plate 110 is retracted state, the first supporting plate 110 through the first supporting plate hinge connected with the first sofa cabinet 1, it also can realize the movable connection by other ways, as shown in FIG. 2. The first sofa cabinet 1 is provided with a first supporting plate driving device 120. The first supporting plate driving device 120 is fixed in the first sofa cabinet 1. The first supporting plate driving device 120 is connected with the first supporting plate 110 through the hinge connection. The first sofa cabinet 1 is provided with two first supporting plate driving device 120, which are fixed in the first sofa cabinet 1, respectively is connected with the first supporting plate 110 two ends. The first supporting plate driving device 120 of the piston rod extends out, the first supporting plate 110 to the first supporting plate hinge as the center to move upwards, to support the first supporting plate driving device 120 the piston rod is retracted when it is needed to be retracted, the first supporting plate 110 is retracted.

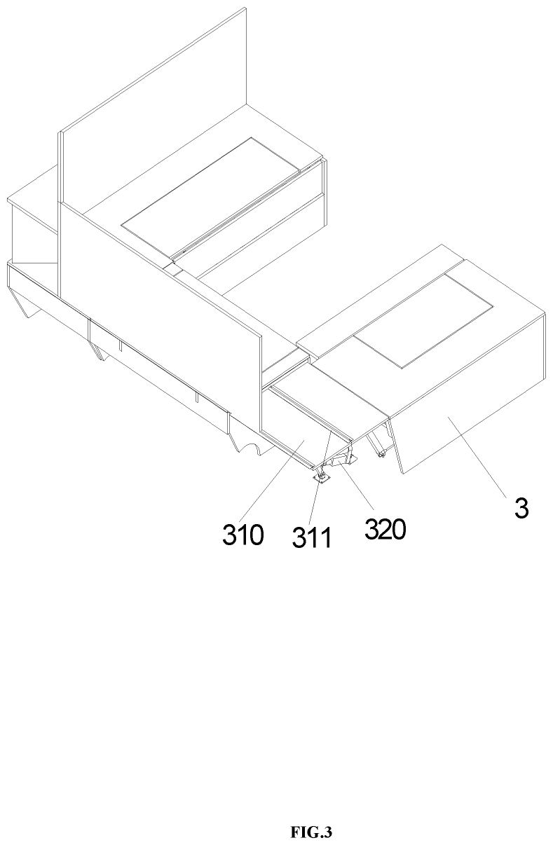

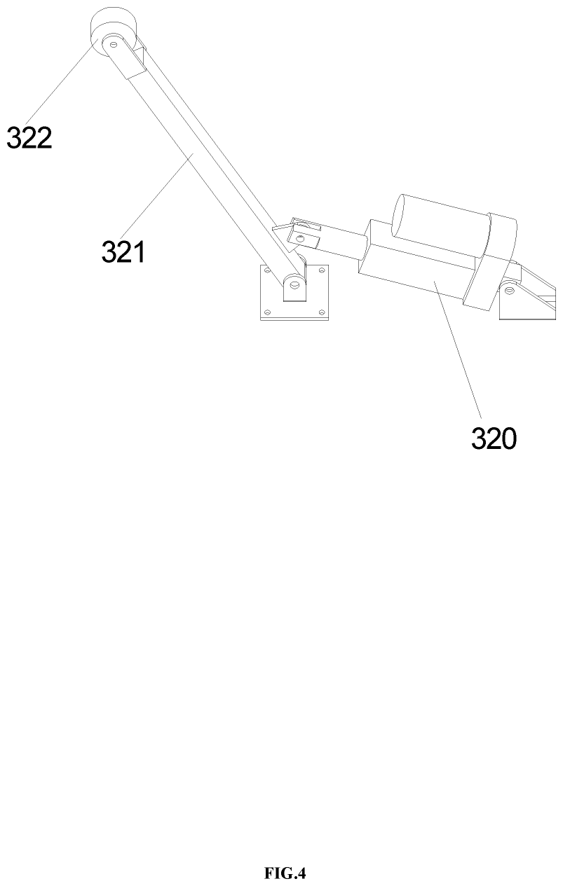

As shown in FIG. 3, the third sofa cabinet 3 is provided with a telescopic plate 310. The telescopic plate 310 located on the third sofa cabinet 3 close to the second sofa cabinet 2 side. The telescopic plate 310 includes two plates. The two plates are hinged through the first telescopic plate hinge 311. The first telescopic plate hinge 311 is arranged outside the telescopic plate 310. The telescopic plate 310 and the third sofa cabinet 3 through the second telescopic plate hinge (not shown in the figure) hinged connection. The second telescopic plate hinge located on the third sofa 3 inner side. The telescopic plate 310 is provided with a fixed on the recreational vehicle floor of the telescopic plate driving device 320, as shown in FIG. 4, telescopic plate driving device 320 of the piston rod is hinged with the telescopic plate push rod 321; one end of the telescopic plate push rod 321 is fixed on the recreational vehicle floor through the hinged way, the other end is provided with a roller 322, the length of the telescopic plate push rod 321 is greater than the height of the telescopic plate 310 from the recreational vehicle floor. when the telescopic plate driving device 320 of the piston rod shrinks, the telescopic plate push rod 321 is supported on the telescopic plate 310, the telescopic plate 310 extends upwards and provides support for it, when the telescopic plate driving device 320 of the piston rod extends, the telescopic plate push rod 321 is reduced, away from the telescopic plate 310. the telescopic plate 310 shrinks downwards, the folding saves space, roller 322 plays the role of rolling, avoiding the telescopic plate push rod 321 damage the telescopic plate 310.

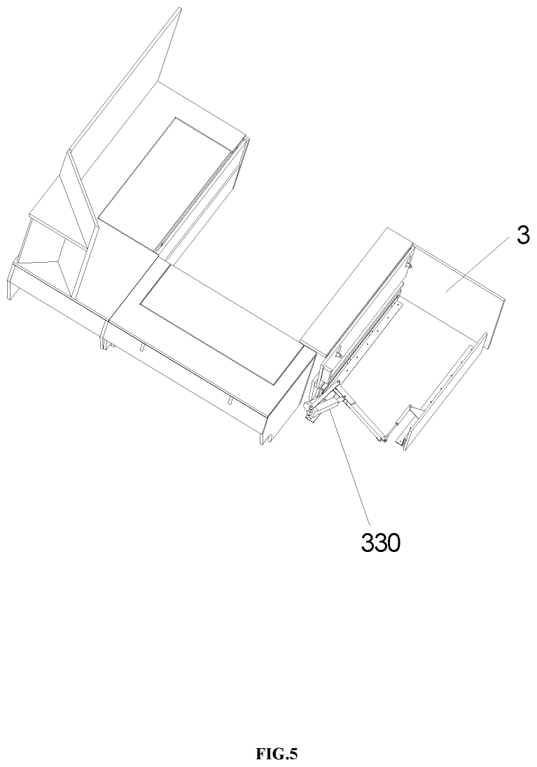

As shown in FIG. 5, 6, the third sofa cabinet 3 is provided with a sofa cabinet driving device 330, a sofa cabinet driving device 330 is fixed on the recreational vehicle floor, the piston rod of the sofa cabinet driving device 330 is hinged with the sofa cabinet push rod 331; one end of the sofa cabinet push rod 331 is fixed on the caravan floor through the hinged way, the other end is hinged with the hydraulic rod 332; the other end of the hydraulic rod 332 is movably connected with the connecting sheet 333 fixed on the inner side of the third sofa cabinet; the third sofa cabinet 3 is provided with a slide rail device 334, the sliding device 334 can be a linear guide rail, a roller slide rail, ball screw slide rail, also can be trapezoidal slide rail or dovetail groove slide rail such as the common sliding device in the market, the sliding device 334 is fixed on the recreational vehicle floor, the third sofa cabinet can move back and forth under the driving of the sliding device 334. the hydraulic rod 332 can reduce the unfolding and retracting speed of the sofa, preventing the electric sofa when working to the human or goods for excessive extrusion damage. when the sofa cabinet driving device 330 of the piston rod extends, the sofa cabinet push rod 331 pushes the hydraulic rod 332, the hydraulic rod 332 pushes the third sofa cabinet 3 to move outwards on the sliding device 334, when the sofa cabinet driving device 330 of the piston rod shrinks, the sofa cabinet push rod 331 drives the hydraulic rod 332. The hydraulic rod 332 drives the third sofa cabinet 3 to be retracted on the sliding device 334.

The telescopic plate driving device 320 and the sofa driving device 330 are controlled by the same controller, both are operated at the same time, the telescopic plate driving device 320 of the piston rod extends, the telescopic plate 310 retracted, at this time, the sofa cabinet driving device 330 of the piston rod shrinks, the third sofa 3, and vice versa.

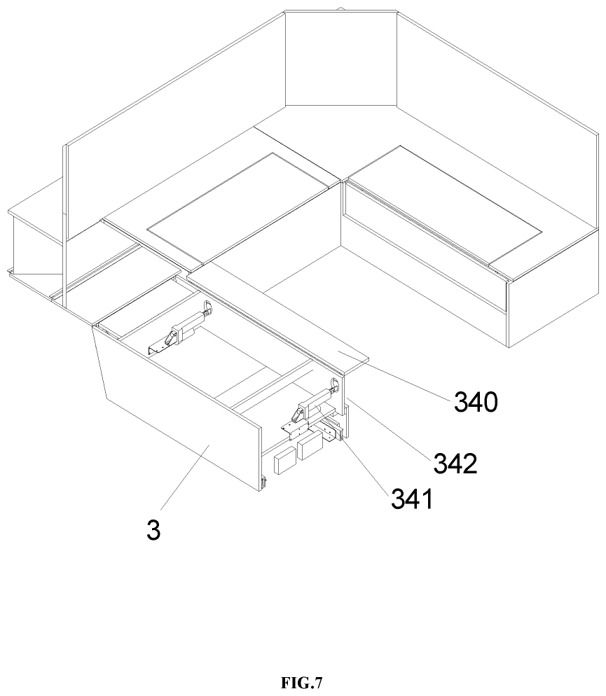

As shown in FIG. 7, the third sofa cabinet 3 is movably provided with a second supporting plate 340, the second supporting plate 340 can be connected by the second supporting plate hinge and the third sofa cabinet 3 can also be movably connected by other ways, the second supporting plate 340 located at one side of the sofa combined cabinet 1; the third sofa cabinet 3 is provided with a second supporting plate driving device 341, the second supporting plate driving device 341 is fixed in the third sofa cabinet 1, the second supporting plate driving device 341 is connected with the second supporting plate 340 through the hinge; the third sofa cabinet 3 is provided with two second supporting plate driving device 341, are fixed in the third sofa 3, and the respectively supporting plate 340 two ends, the second supporting plate driving device 341 of the piston rod extends, the second supporting plate 340 to the second supporting plate hinge as the center to move upwards, plays a role of supporting, when it is needed to be retracted, the second supporting plate driving device 341 piston rod is retracted, the second supporting plate 340 is retracted.

In this embodiment, the sofa combined cabinet 10 middle position is provided with a lifting table (not shown in the figure), when the lifting table height is higher than the sofa combined cabinet 10 can be used as a table, when the lifting table height is lower than the sofa combined cabinet 10 can be combined with the sofa combined cabinet 10 to form a bed.

As shown in FIG. 1, the embodiment of the sofa combined cabinet 10 is further provided with a sofa backrest 4, in this embodiment three sofa cabinet is respectively with a cabinet door 5, the cabinet door 5 can be opened, namely can be used as the access port and can be placed articles.

As shown in FIG. 2, in this embodiment the sofa combined cabinet 10 is provided with a rib 6, for supporting, strengthening the function of the sofa combined cabinet 10.

As shown in FIG. 2, in the embodiment of the first sofa cabinet 1 and the third sofa cabinet 3 is provided with a first supporting plate slot 130 and the second supporting plate slot 342, the first supporting plate slot 130 and the second supporting plate slot 342 the depth of the first supporting plate 110 and the second supporting plate 340 of the same thickness, when the first supporting plate 110 and the second supporting plate 340 retracted can respectively in the first supporting plate slot 130 and the second supporting plate slot 342, avoiding the supporting plate protruding caused by collision in the using process.

Therefore, the electric sofa for recreational vehicle is provided with a telescopic plate, the telescopic plate is driven by the telescopic plate driving device to unfold or shrink, the third sofa cabinet moves along the slide rail device under the driving of the sofa cabinet driving device, when the telescopic plate shrinks, the third sofa cabinet is retracted, the sofa length is reduced, and the use space in the vehicle is increased; it can reserve a wider passage, when the third sofa cabinet is retracted, the third sofa cabinet avoids opening the door of the recreational vehicle; it avoids the problem that the length of the sofa is longer for blocking the door of the recreational vehicle; it is convenient for people to get on and off the vehicle, and improves the use efficiency of the electric sofa. The first sofa cabinet and the second sofa cabinet are further provided with a supporting plate, when it is necessary to rest in the vehicle, the telescopic plate is unfolded, the third sofa cabinet extends out, the supporting plate is opened, the lifting table is matched, the unfolded area of the sofa combined cabinet is increased, after unfolding, it can be used as a bed; therefore, the electric sofa can be used as a bed, and it can be popular by the motor home when the sofa is used, it solves the problem that the sofa occupies larger space in the market and reduces the use space in the vehicle; the sofa is not adjustable, the seat number of the sofa is small, the sofa is easy to block the problem of the door.

Although the embodiments of the present invention have been shown and described, it will be understood by those skilled in the art that various changes, modifications, substitutions and variations can be made to these embodiments without departing from the principles and spirit of the invention, and the scope of the invention is defined by the appended claims and their equivalents.

In the description of the present invention, it should be noted that, unless otherwise specified and defined, the term “installation”, “connection”, “connection” should be broadly understood, for example, can be a fixed connection, also can be detachably connected, or integrally connected; can be mechanical connection, also can be electric connection; it also can be directly connected, also can be indirectly connected through the intermediate medium, can be connected in two elements. For those of ordinary skill in the art, it can be specifically understood that the above term in the specific meaning of the present invention.

What is claimed is:

1. An electric sofa for recreational vehicle, comprising a sofa combined cabinet; the sofa combined cabinet comprises a first cabinet, a second sofa cabinet and a third sofa cabinet; the sofa combined cabinet is of U-shaped distribution; wherein the third sofa cabinet is provided with a telescopic plate, the telescopic plate is located at one side of the third sofa cabinet close to the second sofa cabinet, the telescopic plate is provided with a telescopic plate driving device fixed on the floor of the recreational vehicle, the third sofa cabinet is provided with a sofa cabinet driving device; and the bottom of the third sofa cabinet is provided with a slide rail device.

2. The electric sofa of claim 1, wherein the first sofa cabinet and the third sofa cabinet are respectively provided with supporting plates, and the supporting plates are respectively connected with the supporting plate driving device.

3. The electric sofa of claim 2, wherein the supporting plate driving device is fixed in the sofa cabinet, the supporting plate driving device is connected with the supporting plate by the hinge; each supporting plate is connected with the two supporting plate driving devices; and the supporting plate driving device is located at two ends of the supporting plate respectively.

4. The electric sofa of claim 1, wherein the telescopic plate comprises two plates; the two plates are hinged by a first telescopic plate hinge; the first telescopic plate hinge is located at the outer side of the telescopic plate, the telescopic plate is hinged with the third sofa cabinet through a second telescopic plate hinge; and the second telescopic plate hinge is located at the inner side of the third sofa cabinet.

5. The electric sofa of claim 1, wherein the piston rod of the telescopic plate driving device is hinged with the telescopic plate push rod, one end of the telescopic plate push rod is fixed on the recreational vehicle floor through a hinge mode, and the other end is provided with a roller, the length of the telescopic plate push rod is greater than the height of the telescopic plate from the recreational vehicle floor.

6. The electric sofa of claim 1, wherein the sofa cabinet driving device is fixed on the recreational vehicle floor, the piston rod of the sofa cabinet driving device is hinged with the sofa cabinet push rod; one end of the sofa cabinet push rod is fixed on the caravan floor by the hinge mode, the other end is connected with the hydraulic rod through the hinge mode, the other end of the hydraulic rod is movably connected with the connecting sheet fixed on the inner side of the third sofa cabinet.

7. The electric sofa of claim 1, wherein the sofa combined cabinet is further provided with a sofa backrest, the sofa cabinet is respectively provided with a cabinet door, and the cabinet door can be opened.

8. The electric sofa of claim 1, wherein the first sofa cabinet and the third sofa cabinet are respectively provided with a supporting plate clamping groove, the depth of the supporting plate clamping groove is the same as that of the supporting plate.

9. The electric sofa of claim 1, wherein the inner part of the sofa combined cabinet is provided with a rib plate.

10. The electric sofa of claim 1, wherein the sofa is further provided with a lifting table.
